(19) United States
(12) Patent Application Publication
(10) Pub. No.: US 2015/0101247 A1
(43) Pub. Date: Apr. 16, 2015

(54) Method for remediating soil with single or combined contamination of Cd and Pb by hyperaccumulator Emilia sonchifolia L.

(71) Applicant: Nankai University, Tianjin (CN)

(72) Inventors: Ruiren Zhou, Tianjin (CN); Weitao Liu, Tianjin (CN); Qixing Zhou, Tianjin (CN)

(21) Appl. No.: 14/341,822

(22) Filed: Jul. 27, 2014

(30) Foreign Application Priority Data
Oct. 12, 2013 (CN) 201310474040.5

(51) Int. Cl. A01B 79/02

(52) U.S. Cl. CPC A01B 79/02
USPC 47/58.1 SC

(57) ABSTRACT

A method for remediating soil which is contaminated by an individual or a mixture of Cd and Pb with a hyperaccumulator Emilia sonchifolia L. includes steps of: planting seeds or seedlings of Emilia sonchifolia L. in soil which is contaminated by an individual or a mixture of Cd and Pb; watering regularly to maintain the soil moist; after Emilia sonchifolia L. flowers or completely matures, removing all of or an aboveground part of the plant from a contaminated spot of the soil and disposing the removed plant properly; repeating the above steps until a Cd and Pb content of the soil fall within an environmental security standard. Besides being adaptable and widely available, the Emilia sonchifolia L. is both a Cd hyperaccumulator and a Pb hyperaccumulator by respectively satisfying four indexes of the Cd hyperaccumulator and the Pb hyperaccumulator.

### CROSS REFERENCE OF RELATED APPLICATION

The present invention claims priority under 35 U.S.C. 119(a-d) to CN 201310474040.5, filed Oct. 12, 2013.

### BACKGROUND OF THE PRESENT INVENTION

1. Field of Invention

The present invention relates to a soil remediation technology of remediating soil which is contaminated by an individual or mixture of heavy metal with an ornamental plant, and more specific to a method for remediating contaminated soil by an individual or a mixture of Cd and Pb with the heavy metal hyperaccumulator ornamental plant, Emilia sonchifolia L.

2. Description of Related Arts

With the rapid development in the industrial and agricultural production, the heavy metal contaminated soil has become a severe problem. It is indicated that the urban and the suburb agricultural soil of most Chinese cities have suffered from different degrees of heavy metal contamination, including the Cd contamination and the Pb contamination, by reference 1 and reference 2 (reference 1: Zhou Q. X., Ecology of combined pollution, Beijing, China Environmental Science Press, 1995; reference 2: Sun T. H. et al., Pollution ecology, Beijing, Science Press, 2001). The report from the reference 3 points out 35.9% of a hill region of Jiangsu Province of China which is as large as 14,000 square kilometers has suffered from the Cd contamination and the Pb contamination; and that 10,000 square kilometers of the Xi River basin have 5,500 square kilometers contaminated by the heavy metal including Cd and Pb (reference 3: http://news.sohu.com/20050118/n223993549.shtml). According to a survey of national sewage irrigation area held by Ministry of Agriculture of China, 64.8% of the sewage irrigation area, approximately 1,400,000 hectares, have suffered from the heavy metal contamination including Cd and Pb, wherein more than 8.4% of the sewage irrigation area have been severely polluted. The increasingly severe heavy metal contamination causes a total financial loss of at least 3.3 billion dollars in China each year, including a grain yield reduction of more than 10 million tons and over 12 million tons of heavy metal contaminated grain. As a result, the heavy metal contamination of soil has posed a severe threat to the food safety, the public health and the sustainable development of agriculture of China and even the world (as stated in reference 4: Zhou Q. X., Healthy soil science: soil health quality and safety of agricultural products, Beijing, Science Press, 2005; reference 5: Zhou Q. X, Luo Yi & Sun T. H., Research progress and prospect of pollution eco-chemistry, from China Chemistry Science Series-Academic frontier and prospect of environmental chemistry, Beijing, Science Press, 2011, P 605-615; and reference 6: Peters R W., Chelant extraction of heavy metals from contaminated soils, Journal of Hazardous Materials, 1999, 66(1-2): 151-210).

In order to remediate the heavy metal contaminated soil, various soil remediation technologies have been used, such as physical method, chemical method and biological method (as disclosed in reference 7: Zhou Q. X., Song Y. F., Principle and method of remediation of contaminated soil, Beijing, Science Press, 2004). Among them, the phytoremediation, an in-situ promising green biological remediation technology, has gained a wide attention due to its low cost, environmental harmlessness and public accessibility. Beneficial exploration has been developed in the field of phytoremediation, as well as the relatively systematical screening and researching of the heavy metal hyperaccumulating plants (which are disclosed in reference 8: Su H., Cai Z., Zhou Q. X., Phytoremediation of cadmium contaminated soils: advanced and researching prospects, Materials Science Forum-Energy and Environment Materials, 2013, 743-744:732-744; reference 9: Ali H., Khan E., Sajad M. A., Phytoremediation of heavy metals-Concepts and applications, Chemosphere, 2013, 91(7): 869-881; and reference 10: Eapen S., D'Souza S. F., Prospects of genetic engineering of plants for phytoremediation of toxic metals, Biotechnology Advances, 2005, 23(2): 97-114). Up to now, more than 500 species of plants have been found to be hyperaccumulators, but the majority (more than 300 species) are nickel hyperaccumulators. Under the extensive and in-depth researches about the phytoremediation technology and the heavy metal accumulators in China, the accumulators gradually found in China include Silene fortunei for hyperaccumulating copper; Viola baoshanensis, Solanum nigtrum L., Rorippa globosa (Turcz.) Thell. and Mirabilis Jalapa L. for hyperaccumulating cadmium; Pteris vittata L. and Pteris cretica L. for hyperaccumulating arsenic; Sedum alferdii Hance for hyperaccumulating zinc; Phytolacca acinosa Roxb. for hyperaccumulating manganese; and Leersia hexandra Swartz for hyperaccumulating chromium, so as to fill the blank in the research of China in the respect. However, the vast majority of the above hyperaccumulators only hold the hyperaccumulation effect and the remediation function against a single contamination of heavy metal.

As one of the natural wild ornamental plant, Emilia sonchifolia L., also named as ye xia hong, yang ti cao and shi ging hong in Chinese and lilac tasselflower, is an annual and biennial succulent plant. This plant has an average height of 20-30 cm in the family of Asteraceae. The artificial cultivation of Emilia sonchifolia L. has occurred in China. Conventionally, the Emilia sonchifolia L. has not been used for the soil remediation yet.

### SUMMARY OF THE PRESENT INVENTION

The object of the present invention is to provide a cheap and green method for governing and remediating heavy metal contaminated soil. Because most of the conventional hyperaccumulators had a hyperaccumulation effect and a remediation function against a single type of heavy metal, the present invention can provide a method for remedying soil with an individual or a mixture contamination of Cd and Pb by Emilia sonchifolia L. Compared to prior arts, the method provided by the present invention is not only effective on a Cd contamination and a Pb contamination, but also effective on a Cd and Pb combined contamination. The method also has advantages of low cost, feasibility, environment beautification and wide application and avoids a secondary pollution by avoiding damaging a structure and physiochemical features of soil.

The present invention provides a method for remediating soil which is contaminated by an individual or a mixture of Cd and Pb with a hyperaccumulator Emilia sonchifolia L., the method comprising steps of: planting Emilia sonchifolia L. in soil which is contaminated by an individual or a mixture of Cd and Pb; when a plant of Emilia sonchifolia L. grows into a flowering stage or into a maturation stage, removing all of or an aboveground part of the plant from a contaminated spot of the soil, so as to remove excessive Cd, Pb and other heavy metal in the soil.

The method comprises steps of: sowing seeds of Emilia sonchifolia L. into contaminated soil to-be-remedied, wherein fresh and plump seeds are preferred; the contaminated soil is fine, compact and flattened; the contaminated soil is totally watered and then dried before sowing; 500 g of the seeds are sowed per 667 square meters; then covering a thin layer of fine sand upon the soil and controlling a thickness of the layer to avoid decreasing a germination rate; keeping a seedbed humid and raising seedlings, wherein a greenhouse is preferred for raising the seedling. Alternatively, the method comprises steps of: transplanting seedlings of Emilia sonchifolia L. into the soil which is contaminated by an individual or a mixture of Cd and Pb at a density of 100-200 plants per 667 square meters, wherein the density depends on whether crops or other remediation plants are planted therein and a contamination level of the soil. Alternatively, the method comprises steps of: breeding rhizomes of Emilia sonchifolia L. in autumn, winter or early spring, wherein the rhizomes are preferred to be immature stems having buds; cutting the stems into small segments of 3-7 cm, setting spots 3-6 cm deep at a row interval of 25 cm, and planting three segments in a triangular form at each spot; thereafter covering soil or soil mixture to compost. Further the method comprises steps of: regularly watering to maintain a water content of the soil at 60%-80% of a field moist capacity; when a plant of Emilia sonchifolia L. grows into a flowering stage or a maturation stage, removing all of or an aboveground part of the plant from the contaminated spot, wherein the planted Emilia sonchifolia L. absorb Cd and Pb from the contaminated soil and transfer the absorbed Cd and Pb to the aboveground part; then planting a subsequent batch of Emilia sonchifolia L. and repeating the above steps until a Cd concentration and a Pb concentration of the soil satisfie an environmental safety standard.

When a feeding concentration of Cd in the soil reaches 10 mg/kg, a Cd content of leaf segments of Emilia sonchifolia L. reaches 114.5 mg/kg which surpasses a threshold content of a Cd hyperaccumulator; meanwhile, when a feeding concentration of Pb in the soil reaches 700 mg/kg, a Pb content of the leaf segments of Emilia sonchifolia L. reaches 1315.5 mg/kg which surpasses a threshold content of a Pb hyperaccumulator.

The plant, Emilia sonchifolia L., is both the Cd accumulator and the Pb accumulator. In other words, in an exposure to the soil which is contaminated by an individual or a mixture of Cd and Pb, although Emilia sonchifolia L. has a far greater accumulation to Cd than to Pb, Emilia sonchifolia L. simultaneously satisfies fourth basic indexes of the hyperaccumulator, the threshold content, the contaminant transfer, a tolerance and an accumulation coefficient; especially when the concentration of Cd and the concentration of Pb in the soil is high enough for the concentration of Cd and the concentration of Pb in the aboveground part to reach the respective threshold content, a biomass of the aboveground part has no significant decrease, which means Emilia sonchifolia L. has a strong tolerance to the soil which is contaminated by an individual or a mixture of Cd and Pb.

The Emilia sonchifolia L. of the present invention is an annual and biennial succulent flower in the family of Asteraceae and has a great ornamental value. The Emilia sonchifolia L. prefers warm, shady and humid and grows suitably at a temperature of 20˜32° C. The Emilia sonchifolia L. is relatively tolerant to drought and barren and highly resistive, even able to grow in dry barren terraces, but has no tolerance to waterlogging. Soil hardness is avoided for Emilia sonchifolia L.

The present invention has following merits and beneficial results.

The present invention provides Emilia sonchifolia L. which is well adaptable and brood via sowing or cottage, and needs simple cultivation and management. Particularly, the Emilia sonchifolia L. has relatively good tolerance to the Cd—Pb mixture contamination and relatively good accumulation to Cd and Pb and thus is able to effectively and rapidly remedy the soil which is contaminated by an individual or a mixture of Cd and Pb; moreover, as the green in situ remediation technology, planting Emilia sonchifolia L. is a small and easy project which improves a soil structure and beautifies local environment.

These and other objectives, features, and advantages of the present invention will become apparent from the following detailed description, the accompanying drawings, and the appended claims.

### DETAILED DESCRIPTION OF THE PREFERRED EMBODIMENT

Example of Method for Remediating Individual or Mixture of Cd and Pb contaminated soil by Emilia sonchifolia L.

According to the Example of the present invention, in a method for remedying soil which is contaminated by an individual or a mixture of Cd and Pb with Emilia sonchifolia L., the soil is taken from a southeast suburb of Tianjin Province of China and a type of the soil is humid soil. Via an analysis measurement, the soil has a pH value of 7.8, slightly alkaline, and a mechanical composition of: 32% of sand having a particle size of 2.0-0.02 mm, 44% of powder having a particle size of 0.02-0.002 mm, and 24% of clay having a particle size below 0.002 mm; and thus the soil has a texture of clay loam. Via the analysis measurement, the soil contains 0.21 mg/kg of Cd and 10.3 mg/kg of Pb; according to reference records, background values of Cd and Pb in soil of China are respectively 0.017-0.33 mg/kg and 10.0-56.1 mg/kg; and thus the soil belongs to clean soil.

According to the Example of the present invention, different experiment groups of the soil have different Cd contamination exposure levels which comprise: 0.6 mg/kg, T₁, equivalent to a secondary quality standard value of neutral soil and close to a lower limit of a medium Cd contamination level; 1.0 mg/kg, T₂, equivalent to a secondary quality standard value of alkaline soil; 2.0 mg/kg, T₃, equivalent to twice of the secondary quality standard value of alkaline soil and within the medium Cd contamination level; 5.0 mg/kg, T₄, an intermediate value of the medium Cd contamination level; and 10 mg/kg, T₅, an upper limit of the medium Cd contamination level. It is reported that the Cd contamination level of the soil of a Chinese smelting factory ranges from 11.2 mg/kg to 197.3 mg/kg and averages 70.7 mg/kg. Considering such extreme contamination, besides a Cd control group CK without an addition of heavy metal contamination, the experiment groups of the soil further have three extreme Cd contamination exposure levels of 50 mg/kg T₆, 100 mg/kg T₇ and 150 mg/kg T₈.

Further, the experiment groups of the soil have different Pb contamination exposure levels which comprise: 35 mg/kg, T′₁, equivalent to a first quality standard value; 50 mg/kg, T′₂, equivalent to a lower limit of a medium Pb contamination level; 350 mg/kg, T′₃, equivalent to a secondary quality standard value of alkaline soil; and 700 mg/kg, T′₄, an upper limit of the medium Pb contamination level and twice of the secondary quality standard value of alkaline soil. It is also reported that the Pb contamination level of the soil of the above Chinese smelting factory ranges from 1,004 mg/kg to 9,385 mg/kg and averages 4,020 mg/kg. Considering such extreme contamination, besides a Pb control group CK, the experiment groups of the soil further have an extreme Pb contamination exposure level of 1,000 mg/kg, T′₅, a lower limit of the Pb contamination level of the above smelting factory.

The method comprises steps of: processing the soil with air drying and a 4.0 mm sieve; according to the above contamination exposure levels of the different experiment groups, to the soils of different experiment groups respectively adding analytical reagent (AR) solids of CdCl₂.2.5H₂O and Pb(NO₃)₂ which are mixed uniformly; then respectively filling the mixed soils into correspondent plastic basins (Ø=20 cm, H=15 cm), wherein each plastic basin is filled with 2.0 kg of the soil and then balanced for 1 month before subsequent steps; then raising seedlings via seeds; when the seedlings of wild flowers of Emilia sonchifolia L., without artificial modification, have 4-6 leaves, selecting out the seedlings having identical growth and transplanting the selected seedlings respectively into all the balanced plastic basins; and repeating the step of selecting and transplanting, until each plastic basin has three transplanted seedlings,

In the method, all plastic basins are placed outdoors for cultivating the seedlings without any rain cover. The method further comprises steps of: maintaining a water content of the soil at 60%-80% of a field moist capacity, by irregularly watering with tap water according to a water shortage of the plastic basin soil, wherein a detection of the tap water shows no Cd and Pb; and harvesting plants before frosting in autumn. The harvested plants are divided into four parts comprising root, stem, leaf and seed. The four parts are respectively sufficiently washed with the tap water until the soil and stains attached to the plant parts are removed, then washed with deionized water, drained, darkened for 30 minutes at 105° C., and thereafter dried at 70° C. until a constant weight. The constant weight of each plant part is detected; then the plant parts are pulverized by a pulverizer and sieved with a 60-meshed nylon net before subsequence analysis and detection.

The soil (after being sieved with 100 meshes) and the plant parts are both digested by HNO₃—HClO₄ in a volume ratio of 3:1; a mass concentration of Cd and a mass concentration of Pb in the soil and the plant parts are respectively detected via a flame atomic absorption spectrophotometer, wherein a detection wavelength of Cd is 228.8 nm and a detection wavelength of Pb is 283.3 nm. Detection data are processed with Excel XP, SPSS 13.0 and DPS and a significance test of the detection data is executed through Duncan shortest significant ranges (SSR) method.

According to the basin experiments of Example, the exposure to the Cd contamination generally brings no significant affection on a biomass growth of Emilia sonchifolia L., as showed in Table 1; especially when the Cd contamination exposure level is lower than 0.5 mg/kg, an average biomass of Emilia sonchifolia L. reaches 4.4 g/basin, far higher than an average biomass of the control group CK 3.9 g/basin, which means a low Cd contamination level contributes to the growth and development of the plants Emilia sonchifolia L. When the Cd contamination exposure level increases to 1 mg/kg, 2 mg/kg and 5 mg/kg, an average biomass of Emilia sonchifolia L. is still higher than the average biomass of the control group (CK), which means the three Cd contamination levels are still beneficial to the growth and development of Emilia sonchifolia L. When the Cd contamination exposure level increases to 10 mg/kg and 50 mg/kg, an average biomass of Emilia sonchifolia L. becomes slightly lower than that of the CK, which means Emilia sonchifolia L. has a tolerance to the Cd contamination.

Similarly, the exposure to the Pb contamination generally brings no significant suppression to the biomass of Emilia sonchifolia L., as showed in Table 1. When the Pb contamination exposure level is relatively low (35 mg/kg), the average biomass of Emilia sonchifolia L. reaches to 4.3 g/basin, significantly higher than that of the control group (CK 3.9 g/basin). It means that a low Pb contamination level contributes to the growth and development of the plants Emilia sonchifolia L. When the Pb contamination exposure level is lower than 350 mg/kg, the average biomass of the plants Emilia sonchifolia L. shows no decrease despite of an toxicity of Pb in the soil, which means that Emilia sonchifolia L. have a good tolerance to Pb. Even when the Pb contamination exposure level increases to 700 mg/kg, the average biomass of the plants Emilia sonchifolia L. is not significantly lower than that of the control group, which means that a high Pb contamination level poses no significant threat to the growth and development of Emilia sonchifolia L.

TABLE 1
Biomass of Harvested Emilia sonchifolia L. from Basin
Experiments (g/basin)

| | | | | | Average |
|---|---|---|---|---|---|
| | | Biomass of different repeats | | | biomass ± |
| Treat- | Concentration | in one treatment | | | standard |
| ment | (mg/kg) | Repeat 1 | Repeat 2 | Repeat 3 | deviation |
| None | 0 | 3.9 | 4.2 | 3.5 | 3.9 ± 0.35 |
| Cd | 0.5 | 3.9 | 5.3 | 3.9 | 4.4 ± 0.81 |
| Cd | 1 | 3.7 | 5.0 | 3.7 | 4.1 ± 0.75 |
| Cd | 2 | 4.0 | 4.9 | 3.8 | 4.2 ± 0.59 |
| Cd | 5 | 3.7 | 4.7 | 3.6 | 4.0 ± 0.61 |
| Cd | 10 | 3.5 | 4.6 | 3.4 | 3.8 ± 0.67 |
| Cd | 50 | 3.6 | 4.6 | 3.4 | 3.8 ± 0.72 |
| Cd | 100 | 3.2 | 4.2 | 3.3 | 3.6 ± 0.55 |
| Cd | 150 | 2.9 | 3.9 | 3.6 | 3.3 ± 0.55 |
| Pb | 35 | 4.1 | 4.3 | 4.4 | 4.3 ± 0.15 |
| Pb | 50 | 4.0 | 3.9 | 4.2 | 4.0 ± 0.15 |
| Pb | 350 | 3.8 | 3.9 | 4.0 | 3.9 ± 0.10 |
| Pb | 700 | 3.5 | 3.6 | 3.8 | 3.6 ± 0.15 |
| Pb | 1000 | 3.3 | 3.1 | 3.2 | 3.2 ± 0.10 |

According to the basin experiments of Example, the root of Emilia sonchifolia L. has relatively strong absorption ability to Cd and Pb and thus accumulates more than common plants. Within the concentration level range of the Example, a highest Cd accumulation and a highest Pb accumulation of the roots are respectively 164.3 mg/kg and 819.3 mg/kg, larger than a threshold content of a Cd hyperaccumulator. Even when the soil is without the addition of Cd and Pb, the roots of Emilia sonchifolia L. respectively accumulate 1.1 mg/kg of Cd and 5.4 mg/kg of Pb. When a feeding concentration of Pb in the soil reaches 700 mg/kg, a Pb content of the leaves of Emilia sonchifolia L. reaches 1315.5 mg/kg, larger than a threshold content of a Pb hyperaccumulator. Especially when the addition concentration of Pb in the soil reaches 1000 mg/kg, the stems, the leaves and the seeds of the plants Emilia sonchifolia L. respectively contain 1131.3 mg/kg, 1498.7 mg/kg and 1043.0 mg/kg of Pb, as showed in Table 3; a Pb content sum of an aboveground part of each plant Emilia sonchifolia L. also reaches 1224.3 mg/kg on average, larger than the threshold content of the Pb hyperaccumulator.

According to the Example of the present invention, the Cd accumulation and the Pb accumulation of Emilia sonchifolia L. indicate a regular pattern that the aboveground part has a higher accumulation than the root, as showed in Table 2 and Table 3. For the Cd accumulation, a ratio of the aboveground part to the root is 1.5-2.3; for the Pb accumulation, the ratio of the aboveground part to the root is 1.4-2.1. As a result, Emilia sonchifolia L. accumulates Cd and Pb similarly in a manner of transferring the Cd and Pb absorbed via the roots into the aboveground part.

TABLE 2
Accumulation of Cd in Root and Aboveground Part and its Average
Ratio

| Cd | Cd accumulation (mg/kg) | | Above- | Above- |
|---|---|---|---|---|
| concentration | | Aboveground | ground | ground |
| in soil | root ± standard | part ± standard | part Cd/root | part Cd/soil |
| (mg/kg) | deviation | deviation | Cd | Cd |
| 0 | 1.1 ± 0.15 | 1.6 ± 0.24 | 1.5 | 7.4 |
| 0.5 | 1.5 ± 0.25 | 2.8 ± 0.25 | 1.9 | 4.0 |
| 1 | 4.2 ± 0.52 | 7.3 ± 0.89 | 1.7 | 6.0 |
| 2 | 9.8 ± 0.50 | 20.2 ± 2.12 | 2.1 | 9.2 |
| 5 | 15.7 ± 0.56 | 34.4 ± 4.70 | 2.2 | 6.6 |
| 10 | 26.0 ± 2.29 | 60.9 ± 2.48 | 2.3 | 6.0 |
| 50 | 85.2 ± 6.33 | 189.5 ± 26.60 | 2.2 | 3.8 |
| 100 | 121.8 ± 11.05 | 225.5 ± 20.14 | 1.9 | 2.2 |
| 150 | 164.3 ± 24.04 | 276.2 ± 43.93 | 1.7 | 1.8 |

TABLE 3
Accumulation of Pb in Root and Aboveground Part and its Average
Ratio

| Pb | Pb accumulation (mg/kg) | | Above- | Above- |
|---|---|---|---|---|
| concentration | Root ± | Aboveground | ground | ground |
| in soil | standard | part ± standard | part Pb/root | part Pb/soil |
| (mg/kg) | deviation | deviation | Pb | Pb |
| 0 | 5.4 ± 1.95 | 11.4 ± 1.50 | 2.1 | 1.1 |
| 35 | 51.5 ± 6.50 | 84.6 ± 6.01 | 1.6 | 1.9 |
| 50 | 115.0 ± 5.19 | 161.0 ± 15.96 | 1.4 | 2.7 |
| 350 | 349.2 ± 39.92 | 508.7 ± 36.80 | 1.5 | 1.4 |
| 700 | 700.1 ± 128.86 | 1055.5 ± 28.64 | 1.5 | 1.5 |
| 1000 | 819.3 ± 121.60 | 1224.3 ± 17.54 | 1.5 | 1.2 |

Further, according to the Example of the present invention, a smallest ratio of the Cd accumulation of the aboveground part to the Cd concentration in the soil of Emilia sonchifolia L. is 1.8; especially when the Cd concentration in the soil reaches 2.0 mg/kg, the ratio of the Cd accumulation of the aboveground part to the Cd concentration in the soil is as high as 9.2. Similarly, a ratio of the Pb accumulation of the aboveground part to the Pb concentration in the soil is 1.1-2.7 as showed in Table 3. The ratio of the Pb accumulation of the aboveground part to the Pb concentration in the soil is all larger than 1.0, but much smaller than the ratio of the Cd accumulation of the aboveground part to the Cd concentration in the soil, which means that Emilia sonchifolia L. has far greater accumulation efficiency and greater remediation to Cd than to Pb.

### CONCLUSIONS

As an important ornamental plant, Emilia sonchifolia L. not only satisfies four basic indexes of the Cd hyperaccumulator comprising a threshold content, a contaminant transfer, a tolerance and an accumulation coefficient within a certain Cd concentration range, but also satisfies four basic indexes of the Pb hyperaccumulator within a certain Pb concentration range. Thus, Emilia sonchifolia L. is recognized as the Cd hyperaccumulator and the Pb hyperaccumulator, wherein Emilia sonchifolia L. has better accumulation efficiency and better remediation to Cd than to Pb from the index of the accumulation coefficient.

The plants of Emilia sonchifolia L. is both the Cd hyperaccumulator and the Pb hyperaccumulator; roots of the plants are able to absorb and accumulate a large amount of Cd and Pb in the contaminated soil and transfer the absorbed Cd and Pb to the aboveground parts. When the plants grow into a flowering stage or a maturation stage, all of each plant or the aboveground part of each plant is removed and disposed properly, so as to remove the abundant Cd and Pb in the soil. Especially when the plants of Emilia sonchifolia L. are sold as the ornamental flower commodities, the plants automatically processes the biomass while bringing financial benefits. In such sense, the plants of Emilia sonchifolia L. have great application values in the remediation of the soil which is contaminated by a mixture of Cd and Pb, because the plants of Emilia sonchifolia L. have tolerance and accumulation ability to both Cd and Pb.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for remediating an individual or a mixture of Cd and Pb contaminated soil by an ornamental plant Emilia sonchifolia L., comprising steps of: planting Emilia sonchifolia L. in soil which is contaminated by an individual or a mixture of Cd and Pb; when a plant of Emilia sonchifolia L. grows into a flowering stage or a maturation stage, removing all of or an aboveground part of the plant from contaminated soil; and then eliminating the Cd and Pb contaminants from the soil.

2. The method, as recited in claim 1, wherein the step of “planting Emilia sonchifolia L. in soil which is contaminated by an individual or a mixture of Cd and Pb” comprises steps of: sowing seeds of Emilia sonchifolia L. in the contaminated soil, or transplanting seedlings of Emilia sonchifolia L. into the soil; and maintaining a water content of the soil at 60%-80% of a field moist capacity by regularly watering.

3. The method, as recited in claim 1, after the step of “when a plant of Emilia sonchifolia L. grows into a flowering stage or a maturation stage, removing all of or an aboveground part of the plant from a contaminated spot of the soil”, further comprising steps of: planting a subsequent batch of Emilia sonchifolia L. and repeating the previous steps until a Cd content and a Pb content of the soil fall within a environmental security standard.

4. The method, as recited in claim 2, after the step of “when a plant of Emilia sonchifolia L. grows into a flowering stage or a maturation stage, removing all of or an aboveground part of the plant from a contaminated spot of the soil”, further comprising steps of: planting a subsequent batch of Emilia sonchifolia L. and repeating the previous steps until a Cd content and a Pb content of the soil fall within a environmental security standard.

5. The method, as recited in claim 1, wherein when a feeding concentration of Cd in the soil reaches 10 mg/kg, a Cd content of leaves of Emilia sonchifolia L. reaches 114.5 mg/kg, larger than a threshold content of a Cd hyperaccumulator; and when a feeding concentration of Pb in the soil reaches 700 mg/kg, a Pb content of the leaves of Emilia sonchifolia L. reaches 1315.5 mg/kg, larger than a threshold content of a Pb hyperaccumulator.

6. The method, as recited in claim 2, wherein when a feeding concentration of Cd in the soil reaches to 10 mg/kg, a Cd content of leaves of Emilia sonchifolia L. reaches to 114.5 mg/kg, larger than a threshold content of a Cd hyperaccumulator; and when a feeding concentration of Pb in the soil reaches 700 mg/kg, a Pb content of the leaves of Emilia sonchifolia L. reaches to 1315.5 mg/kg, larger than a threshold content of a Pb hyperaccumulator.
